(19) United States
(12) Patent Application Publication
(10) Pub. No.: US 2007/0161262 A1
(43) Pub. Date: Jul. 12, 2007

(54) Detachable magnetic electrical connector

(76) Inventor: James Taylor Lloyd, New York, NY (US)

Correspondence Address: STEVEN A. GARNER, ESQ.;CONAIR CORPORATION, ONE CUMMINGS POINT ROAD, STAMFORD, CT, 06902, US

(21) Appl. No.: 11/327,797

(22) Filed: Jan. 6, 2006

(51) Int. Cl. H01R 11/30

(52) U.S. Cl. 439/39

(57) ABSTRACT

A connector body (10) attached to an appliance has a first body (12) with four contact receptacles (24-30) and a magnet (20, 22) which is adapted to attach and detach from a second body (14) having four contact pins (34-40) and a ferrous metal plate (32). The second body (14) is attached to an electrical cord (16) with a grounded plug (18). Two of the pins are the live electrical connections, and the other two pins are ground connections, co-existing so that as long as one remains in contact the grounded connection for the appliance exists. The two ground connections are spatially located relative to one another so that no matter which direction break-away occurs, at least one will always be in connection until the live connection is broken first.

### CROSS-REFERENCE TO RELATED APPLICATIONS

None.

### TECHNICAL FIELD

The present invention relates to electrical plug connectors and, more particularly, to a detachable plug connector with a connection to a ground and break-away capability for safety.

### BACKGROUND OF THE INVENTION

Electrical appliances having a power cord for attachment to an electrical outlet sometimes have break-away capable power cords for safety in situations when it is desirable to have an electrical connection disconnect under certain circumstances. Such break-away cords exist in the form of magnetic, break-away connectors attached to heat control probes. A probe heater connection and two electrical contacts are housed in an end connector having a magnetic plate that mates with a magnetic plate on an appliance. When force is applied to the electrical cord attached to the housing, force sufficient to pull apart the magnetic plates will result in detachment of the cord.

### OBJECTS OF THE INVENTION

In some situations it is desirable to provide a break-away plug for an appliance wherein the break-away is to occur between the appliance and the power cord, and where grounding is required. At present, no known break-away connectors provide break-away capability and the ability to establish a connection to ground, as it is usually not a safety or technical requirement. Specifically, where it is required that a connection to ground must be established before a live connection, and no matter what direction the connection breaks away the ground connection will be the last to be broken.

This object, as well as others, are achieved by the present invention.

### BRIEF SUMMARY OF THE INVENTION

The present invention achieves the above-mentioned objects by utilizing a connector body attached to an electrical cord with a standard grounded plug in which four contact pins and a ferrous metal plate are positioned. A complementary connector attached to an electric appliance has corresponding female connections that engage the pins, as well as a magnet that engages the metal plate. Two of the pins are the live electrical connections, and the other two pins are ground connections, co-existing so that as long as one remains in contact the grounded connection for the appliance exists. The two ground connections are spatially located relative to one another so that no matter which direction break-away occurs, at least one will always be in connection until the live connection is broken first.

### BRIEF DESCRIPTION OF THE DRAWINGS

FIG. 1 is a schematic, exploded view of a break-away electrical connector assembly according to the present invention.

FIG. 2 is a schematic, end view of a component of the assembly of FIG. 1.

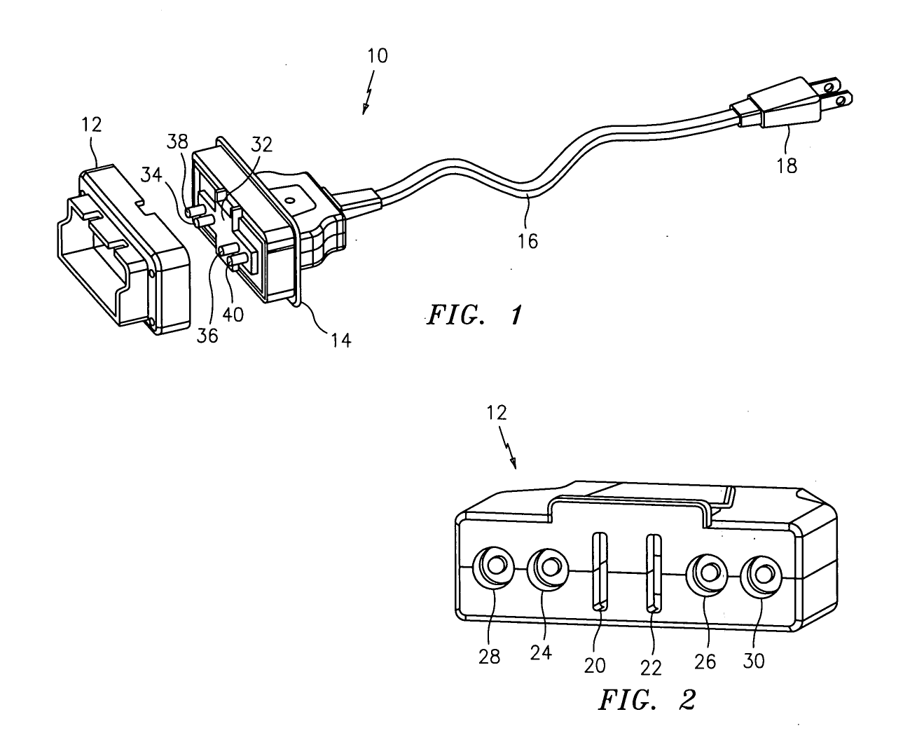

### DESCRIPTION OF THE PREFERRED EMBODIMENT

A break-away electrical connection assembly (10) according to the present invention comprises a first housing (12) adapted to be mounted onto an appliance (not shown), and a second housing (14) adapted to be mounted to an electrical cord (16) having a grounded plug (18). The first and second housings described below can each be attached to either the appliance or the cord, respectively, so that they may be reversed with respect to the embodiment described below.

The first housing (12) has a pair of magnets (20, 22), a pair of live electrical terminals (24, 26), and a pair of ground terminals (28, 30). The terminals (24-30) may be male or female type, and in the preferred embodiment are female.

The second housing (14) comprises a ferrous plate (32) that engages the magnets (20,22), a pair of live electrical terminal pins (34, 36), and a pair of ground terminal pins (38, 40).

The ground terminals (28, 30) and the ground terminal pins (38, 40) are each, respectively, positioned on the first housing and the second housing at the outermost ends, i.e., so that the live electrical terminals are centered between the ground terminals and ground pins. This arrangement enables a ground connection, i.e., at least one side, to always occur prior to a live electrical connection, and it enables the ground connection to remain on at least one side until after the live electrical connection is broken. For example, if the first housing and the second housing are separated at an angle to one side, the first elements to disengage will be on the far side, such as terminal (30) and terminal pin (40), while the last elements to disengage will be terminal (28) and terminal pin (38). If the direction of separation is reversed, then the sequence of element disengagement is reversed. In either situation, the live electrical connections (24, 26, 34, 36) will disengage prior to the last of the ground terminal and ground pin to disengage. If the first and second housing are pulled apart in a straight line, then all elements will be simultaneously separated, so that no live electrical connection exists longer than a ground connection. In ordinary use, one of the above separation situations occurs when the cord (16) is pulled with sufficient force to sever the magnetic connection between the magnets (20, 22) and the plate (32).

While the preferred embodiment of the present invention has been herein described, various modification may be made without departing from the scope of the present invention.

1. An electrical connection assembly for use with an electrical appliance, said assembly comprising
a first housing adapted to be attached to one of an appliance or an electrical cord having a grounded plug; and
a second housing adapted to be selectively attached to and detached from said first housing to establish an electric connection with said first housing and to establish an electrical ground connection with said first housing,
wherein said first housing and said second housing are adapted to be disconnected when a predetermined amount of tension is applied to said cord and wherein said electric connection is broken before said electrical ground connection is broken when said second housing is detached from said first housing at any angle.

2. (canceled)

3. An assembly according to claim 1, further comprising
a magnet on at least one of said first housing or said second housing, and a ferrous plate on the other of said first housing or said second housing, such that a magnetic coupling occurs when said first housing and said second housing are engaged.

4. An assembly according to claim 3, wherein
said first housing and said second housing are adapted to be disconnected when a predetermined amount of tension sufficient to pull apart said magnetic coupling between said magnet and said ferrous plate is applied to said cord.

5. An assembly according to claim 1, further comprising
at least two ground terminals on said first housing;
at least two ground terminal pins on said second housing adapted to be received, respectively, in said ground terminals to establish a ground connection;
at least one live electrical terminal on said first housing positioned between said ground terminals; and
at least one live electrical terminal pin on said second housing positioned between said ground terminal pins adapted to be received in said live electrical terminal to establish a live electrical connection.

6. An assembly according to claim 5, further comprising
a magnet on at least one of said first housing or said second housing, and a ferrous plate on the other of said first housing or said second housing, such that a magnetic coupling occurs when said first housing and said second housing are engaged.

7. An assembly according to claim 6, wherein
said first housing and said second housing are adapted to be disconnected when a predetermined amount of tension sufficient to pull apart said magnetic coupling between said magnet and said ferrous plate is applied to said cord.
